(19) United States
(12) Patent Application Publication
(10) Pub. No.: US 2019/0059132 A1
(43) Pub. Date: Feb. 21, 2019

(54) COOKING CONTAINER COMPRISING AN ENERGY RECOVERY DEVICE

(71) Applicant: SEB S.A., Ecully (FR)

(72) Inventor: Benoît LINGLIN, Saint Martin Bellevue (FR)

(21) Appl. No.: 15/763,963

(22) PCT Filed: Sep. 27, 2016
(86) PCT No.: PCT/FR2016/052451

§ 371 Date: Mar. 28, 2018

(30) Foreign Application Priority Data
Sep. 29, 2015 (FR) 1559192

(51) Int. Cl. H05B 6/12; A47J 36/02; A47J 37/10

(52) U.S. Cl. CPC H05B 6/1209; A47J 37/108; A47J 37/105; A47J 36/02

(57) ABSTRACT

A cooking container includes a bowl that includes a base, a side wall and an energy recovery device intended to engage with an induction heating system, the energy recovery device including a rigid holder that is separate from the bowl, is in the shape of a loop and is arranged on the base, and at least one electrically insulated conductive element attached to the holder by deposition, in particular by screen printing, pad printing, thermal spraying, decalcomania or laser sintering. The holder includes an open loop including two free ends and two extensions that extend radially and without touching one another, starting at the two free ends, from the base towards the side wall, and the conductive element is attached to the open loop and to the two extensions by deposition.

This invention concerns a cooking container intended to be arranged on an induction heating means for the cooking of food, in particular a frying pan, a saucepan, a skillet, a Dutch oven or a pressure cooker, more specifically a cooking container comprising an energy recovery device generating electricity from a magnetic flux produced by the induction heating means in order to power an electric and/or electromechanical device arranged on the cooking container.

From the document FR3010293, we know of a cooking container comprising a bowl that includes a base, a side wall and an energy recovery device intended to cooperate with an induction heating means. The energy recovery device comprises a rigid holder in the shape of a closed loop arranged in the base and a part lateral to the loop extending radially on the base and on the side wall. An electrically insulated conductive element is attached to the rigid holder by means of deposition. The conductive element is intended to recover energy by being the site of an electric current when it is immersed in the magnetic flux produced by the induction heating means.

However, when immersed in the magnetic flux produced by the induction heating means, the closed loop of the holder is the site of an induced current that produces heating by joule effect of the closed loop of the holder. Such heating may lead to degradation of the conductive element attached to the holder.

The goal of this invention is to remedy the aforementioned drawbacks and to propose a cooking container equipped with an energy recovery device that offers reliable and repeatable operation, durable over time.

Another goal of the invention is to propose a cooking container equipped with an energy recovery device that has a simple design and is economical to use.

These goals are achieved with a cooking container comprising a bowl that includes a base, a side wall and an energy recovery device intended to cooperate with an induction heating means, the said energy recovery device comprising a rigid holder separate from the bowl, in the shape of a loop arranged on the base, and at least one electrically insulated conductive element attached to the holder by means of deposition, in particular by means of screen printing, pad printing, thermal spraying, decalcomania or laser sintering, characterized in that the holder comprises an open loop comprising two free ends and two extensions that extend radially without touching one another, starting at the two free ends, from the base to the side wall, and in that the conductive element is attached by means of deposition to the open loop and to the two extensions.

Thus, the energy recovery device comprises a holder that has an open loop and two extensions which, when immersed in the magnetic flux produced by the induction heating means, do not permit the circulation of an induced current, contrary to a closed loop. Consequently, the loop of the holder does not heat up by joule effect, which improves the life span of the conductive elements attached to the holder by means of deposition.

“The conductive element is attached to the rigid holder by means of deposition” is understood to mean that the conductive element is not intrinsically rigid before being deposited and secured to the rigid holder. Advantageously, the conductive element comprises a metallic powder that is attached to the holder by means of a thermal process. Even more advantageously, the metallic powder may be combined with a binder to form a pasty liquid to facilitate its deposition. In a variant, the powder is combined with a binder to form a track arranged on a temporary holder before being deposited on the rigid holder.

In the energy recovery device, the holder does not have energy recovery capability. Only the conductive element placed in the magnetic flux produced by the induction heating means ensures the energy recovery.

Advantageously, the holder is made of a non-ferromagnetic material, in particular an austenitic stainless steel.

This arrangement avoids heating the holder when it is immersed in the magnetic flux produced by the induction heating means.

Preferably, the bowl comprises a housing for receiving the holder to permit the base to be part of a plane.

This arrangement permits the surface of the base to cooperate properly with a heating means having a flat mounting surface.

Advantageously, the holder comprises an outer face oriented to the outside of the bowl and intended to be arranged opposite the induction heating means, the conductive element being arranged on the said outer face, and the outer face equipped with the conductive element is set back by a distance d from the plane of which the base is a part.

Thus, when the cooking container cooperates with the induction heating means, the conductive element is arranged at a distance d, as close as possible to the inductor of the induction heating means in order to optimize the energy recovery. In addition, a space is created between the conductive element and the flat mounting surface. Such a space permits avoiding impacts on the conductive element during successive depositions on the heating means or on a work surface.

Preferably, the distance d is between 0.1 and 2 millimeters.

Such a distance between the conductive element and the plane of which the base is a part is a good compromise to permit good energy recovery capacity and good protection capacity.

Advantageously, the cooking container comprises a metal plate made of a ferromagnetic material, and the housing for receiving the holder is formed in the metal plate.

Preferably, the holder comprises means for attachment on the metal plate.

If the holder has a non-coated inner surface, such an arrangement permits promoting contact between the inner face of the holder and the metal plate, thus avoiding the formation of loops between 2 points of contact, which generate induced currents in the holder.

Advantageously, the holder consists of a metal strip having a substantially constant cross section.

This arrangement makes it possible to produce a holder made of an element extruded or spun from raw material. The manufacturing process for such a holder is therefore particularly economical.

Preferably, the holder has a substantially constant rectangular cross section, with a thickness e of between 0.5 and 2 millimeters, preferably from 0.5 to 0.8 millimeter.

This arrangement permits obtaining a holder that is sufficiently rigid to be manipulated during its manufacture before being attached to the bowl, but sufficiently thin that it can be easily arranged in the base of the cooking container.

Preferably, the conductive element is surrounded by an insulating layer formed by deposition of material resistant to a temperature higher than 350° C., in particular glass frit, ceramic or enamel.

This arrangement permits obtaining an electric device that can withstand high temperatures and chemical attacks of detergents during washing, in particular in a dishwasher. In addition, the process used to make the insulating layer may be the same as the type used to make the conductive element.

Preferably, the cooking container is a frying pan, a saucepan, a skillet, a Dutch oven or a pressure cooker.

The invention will be more fully understood in consideration of the embodiments, which are in no way restrictive, illustrated in the attached figures, in which:

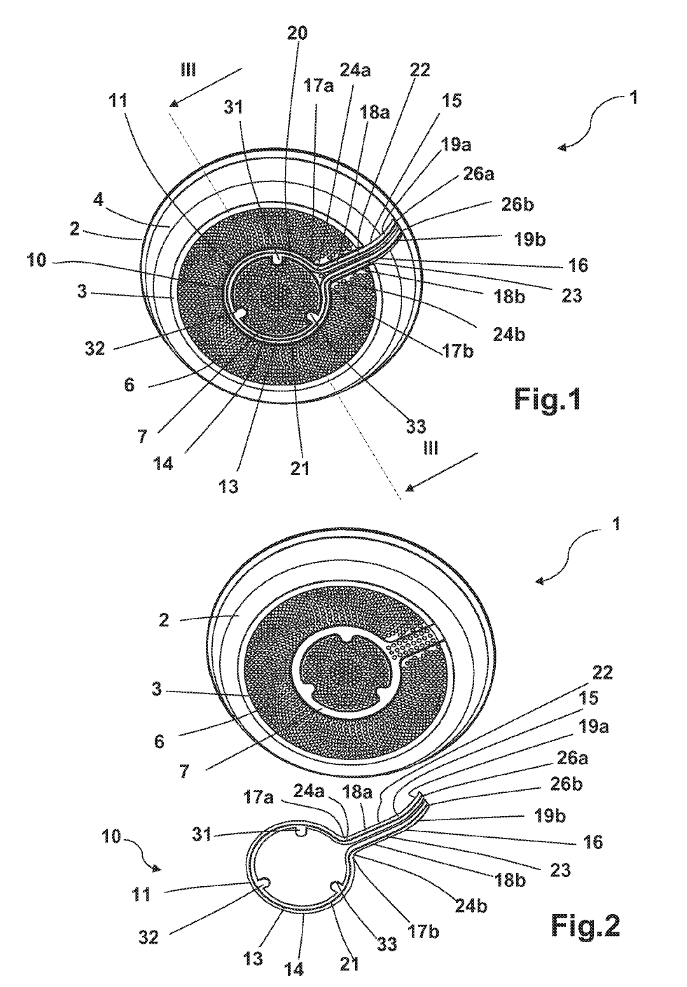

FIG. 1 illustrates a perspective view of a bowl of a cooking container equipped with an energy recovery device according to a particular embodiment of the invention.

FIG. 2 illustrates an exploded perspective view of the bowl of the energy recovery device of FIG. 1.

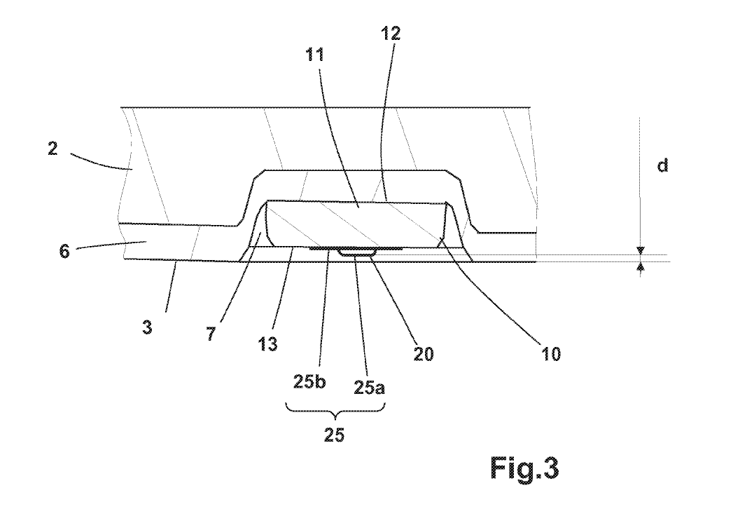

FIG. 3 illustrates a cross-sectional detail view of the bowl and of the energy recovery device of FIG. 1 according to the line III-III.

According to an embodiment seen in FIGS. 1 to 3, a cooking container 1 comprises a bowl 2 that includes a base 3 and a side wall 4. The bowl 2 comprises an energy recovery device 10 which is embedded in the base 3. The energy recovery device 10 comprises a rigid holder 11, separate from the bowl 2.

The bowl 2 comprises a perforated metal plate 6 attached by impact to the base 3. The metal plate 6 is made of ferromagnetic stainless steel in order to ensure compatibility with an induction heating means. The base 3 comprises a housing 7 also made by impact, preferably during the crimping of the metal plate 6 on the base 3. The housing 7 has a shape adapted to receive the holder 11. The holder 11 is positioned in the housing 7, in particular so that the base 3 has a flat surface intended to be positioned on the mounting plane of a heating means.

The holder 11 has an open loop 14 arranged concentric to the base 3. The open loop 14 comprises two ends 17a, 17b from which two extensions 15, 16 extend from the base 3 to the side wall 4. Each extension 15, 16 comprises a straight part 18a, 18b, lateral to the open loop 14 and extending radially on the base 3, and a curved part 19a, 19b extending on the side wall 4. Preferably, the two extensions 15, 16 are parallel and thus, a space separates the two extensions 15, 16 to prevent them from touching one another.

The holder 11 comprises an inner face 12 (FIG. 3) oriented to the bowl 2 and an outer face 13 oriented to the outside of the bowl 2. A conductive element 20 is attached by means of deposition to the outer face 13 of the holder 11. The conductive element 20 is intended to cooperate with the induction heating means. The conductive element 20 forms a coil generating electricity from a magnetic field produced by the induction heating means when the cooking container is placed on the heating means. The electricity generated by the coil permits powering an electric and/or electromechanical device arranged on the cooking container (not shown in the figures).

The conductive element 20 arranged on the holder 11 has an open loop 21 equipped with two ends 24a, 24b from which two lateral portions 22, 23 extend radially. The open loop 21 is arranged on the open loop 14 of the holder 11 and the lateral portions 22, 23 on the straight parts 18a, 18b and the curved parts 19a, 19b. The conductive element 20 is electrically insulated by an insulating layer 25 (FIG. 3). The conductive element 20 and the insulating layer 25 are attached to the holder 11 by means of deposition. The conductive element 20 comprises two ends 26a, 26b intended to be electrically connected with a control circuit arranged, for example, in a handle (not shown in the figures). The control circuit may comprise, for example, means for treatment and display and/or means for communication with the heating means or a remote terminal.

The open loop of the holder 11 comprises three internal protrusions 31, 32, 33 arranged at 120° in order to permit the holder 11 to be attached by welding on the metal plate 6 in the housing 7. The base 3 is part of a plane and the outer face 13 equipped with a conductive element 20 is set back from the plane of which the base is a part by a distance d. Advantageously, the distance d is between 0.1 and 2 millimeters.

“A support 11 separate from the bowl 2” is understood to mean that the holder 11 and the bowl 2 are two different pieces. The holder 11 equipped with the conductive element 20 may be made as a subassembly. The holder 11 consists of a metal strip having a substantially constant rectangular cross section, a width of between 5 and 30 millimeters, preferably 10 millimeters, and a thickness of between 0.3 and 3 millimeters, preferably 0.8 millimeters. The material of which the holder 11 is made is a stainless steel, preferably austenitic. The holder 11 is made and then a first part 25a (FIG. 3) of the insulating layer 25, for example a glass frit, is deposited on the outer face. The conductive element 20 is then deposited, for example a silver frit. Finally, a second part 25b of the insulating layer 25 is deposited.

In operation, the user places on the heating means the bowl 2 of the cooking container 1. The cooking container 1 may comprise a handle that includes an electric or electromagnetic device (not shown in the figures). The user turns on the induction heating means. The coil of the conductive element 20 placed in the magnetic field generated by the induction heating means then provides a current transmitted to the electric or electromagnetic device arranged on the cooking container 1.

Of course, the invention is in no way limited to the embodiments described and illustrated, which have been provided only as examples. Modifications are still possible, in particular from the point of view of composition of the various components or by substitution of equivalent techniques, without departing from the scope of protection of the invention.

Thus, in an embodiment variant, the energy recovery device comprises a holder equipped with two conductive elements arranged side by side in order to increase the quantity of energy recovered.

1. Cooking container comprising a bowl that includes a base, a side wall and an energy recovery device intended to cooperate with an induction heating system, the energy recovery device comprising a rigid holder separate from the bowl, in the shape of a loop arranged on the base, and at least one electrically insulated conductive element attached to the holder by deposition, wherein the holder comprises an open loop comprising two free ends and two extensions that extend radially without touching one another, starting at the two free ends, from the base to the side wall, and wherein the conductive element is attached by deposition to the open loop and to the two extensions.

2. The cooking container according to claim 1, wherein the holder is made of a non-ferromagnetic material.

3. The cooking container according to claim 1, wherein the bowl comprises a housing for receiving the holder to permit the base to be part of a plane.

4. The cooking container according to claim 3, wherein the holder comprises an outer face oriented to the outside of the bowl and intended to be arranged opposite the induction heating system, wherein the conductive element is arranged on the outer face, and wherein the outer face equipped with the conductive element is set back by a distance d from a plane of which the base is a part.

5. The cooking container according to claim 4, wherein the distance d is between 0.1 and 2 millimeters.

6. The cooking container according to claim 3, further comprising a perforated metal plate made of a ferromagnetic material and wherein the housing for receiving the holder is formed in the metal plate.

7. The cooking container according to claim 6, wherein the holder comprises means for attachment on the metal plate.

8. The cooking container according to claim 1, wherein the holder consists of a metal strip having a substantially constant cross section.

9. The cooking container according to claim 8, wherein the holder has a rectangular cross section of thickness e of between 0.3 and 3 millimeters.

10. The cooking container according to claim 1, wherein the conductive element is surrounded by an insulating layer formed by deposition of material resistant to a temperature higher than 350° C.

11. The cooking container according to claim 1, wherein the cooking container is a frying pan, a saucepan, a skillet, a Dutch oven or a pressure cooker.

12. The cooking container according to claim 1, wherein the at least one electrically insulated conductive element is attached to the holder by screen printing, pad printing, thermal spraying, decalcomania or laser sintering.

13. The cooking container according to claim 2, wherein the holder is made of an austenitic stainless steel.

14. The cooking container according to claim 9, wherein the holder has a rectangular cross section of thickness e of between 0.5 and 0.8 millimeters.

15. The cooking container according to claim 10, wherein the material is a glass frit, ceramic or enamel.
